(19) United States
(12) Patent Application Publication
(10) Pub. No.: US 2007/0255433 A1
(43) Pub. Date: Nov. 1, 2007

(54) Method and system for automatically selecting digital audio format based on sink device

(76) Inventor: Eugene Kim Choo, San Diego, CA (US)

Correspondence Address: ROGITZ & ASSOCIATES, 750 B STREET, SUITE 3120, SAN DIEGO, CA, 92101, US

(21) Appl. No.: 11/411,181

(22) Filed: Apr. 25, 2006

(51) Int. Cl. G06F 17/00

(52) U.S. Cl. 700/94

(57) ABSTRACT

A digital multimedia source device automatically discovers the type of sink device it is sending data to, and based on sink device type automatically selects which audio format to send with the video. For example, lower bit rate audio such as stereo PCM can be sent from a source device such as a DVD player when the DVD player senses that the sink device is a TV with relatively lower audio playback capabilities, while higher bit rate audio such as surround-sound AC3 or super audio CD-DSD can be sent to sink devices such as home theater receivers that have relatively higher audio playback capabilities.

### FIELD OF THE INVENTION

The present invention relates generally to selecting a digital audio stream from a source device as appropriate for the sink device.

### BACKGROUND OF THE INVENTION

When a digital multimedia source device, such as a DVD player, sends a signal to the sink device to which it is connected, it sends digital audio with the video. The digital audio format sent to the sink device (e.g. a television set, home entertainment system, etc.) may be either a low bit rate digital audio format or a high bit rate digital audio format. An example of a lower bit rate digital audio format would be a typical household stereo, while an example of a higher bit rate digital audio format would be a surround sound audio format for a home entertainment system or theater. The source either can send the high bit rate digital audio format, or it can send the low bit rate digital audio format but the one it chooses to send may not utilize maximum digital audio potential. For instance, because TVs typically can play only lower bit rate audio, a source consequently might be configured to send lower bit rate audio to ensure that if a TV is the sink, the audio can be played, but this means that if the sink is a home entertainment system its capabilities are not being maximally used. Critically recognizing that sources do not possess the capability to automatically determine sink device type, the present invention provides a method for the digital multimedia source device to automatically detect the type of sink device to which it is connected and optimize audio delivery accordingly.

### SUMMARY OF THE INVENTION

A method for providing digital audio to a sink device includes establishing communication between a multimedia source device and the sink device, and at the source device, determining a type of sink device based on information from the sink device. The method also includes, at the source device, automatically selecting an audio format to provide to the sink device based at least in part on the type of sink device.

In non-limiting implementations a first audio format is provided using at least two audio channels and a second audio format is provided using at least one more audio channel than is used in the first audio format. The first audio format may be pulse code modulation (PCM) and the second audio format may be AC3 or Super Audio compact disk-direct stream digital (CD-DSD). Stated a bit more generally, the first audio format can be a stereo format and the second audio format can be a surround sound format. In an exemplary non-limiting embodiment the source device can be a DVD player and the sink device can be a TV, in which case the first audio format is provided to the TV. In another exemplary non-limiting embodiment the source device can be a DVD player and the sink device can be a home theater receiver, in which case the second audio format is provided to the receiver.

In another aspect, a digital multimedia source device has a processor and a data store storing multimedia streams including at least first and second audio formats. The first audio format has a relatively lower bit rate than the second audio format. A switch is provided, and the processor automatically controls the switch to select at least one of the formats for output to a sink device, based on a type of sink device.

In one implementation that is not delimiting, the processor moves the switch to a first configuration in which the second format is provided on first and second source ports based on the processor determining a sink type of relatively high audio capability. On the other hand, the processor moves the switch to a second configuration in which the first format is provided on the first source port and the second format is provided on the second source port based on the processor determining a sink type of relatively low audio capability.

In yet another aspect, a processor has means for determining a multimedia sink device type, and means, responsive to the means for determining, for automatically configuring a multimedia source device to output at least one audio format.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic diagram of a non-limiting implementation of the present system;

FIG. 2 is a flow chart of a non-limiting example of the logic that may be implemented by the present system;

FIG. 3 shows the switch in the low bit rate configuration; and

FIG. 4 shows the switch in the high bit rate configuration.

### DETAILED DESCRIPTION OF THE PREFERRED EMBODIMENT

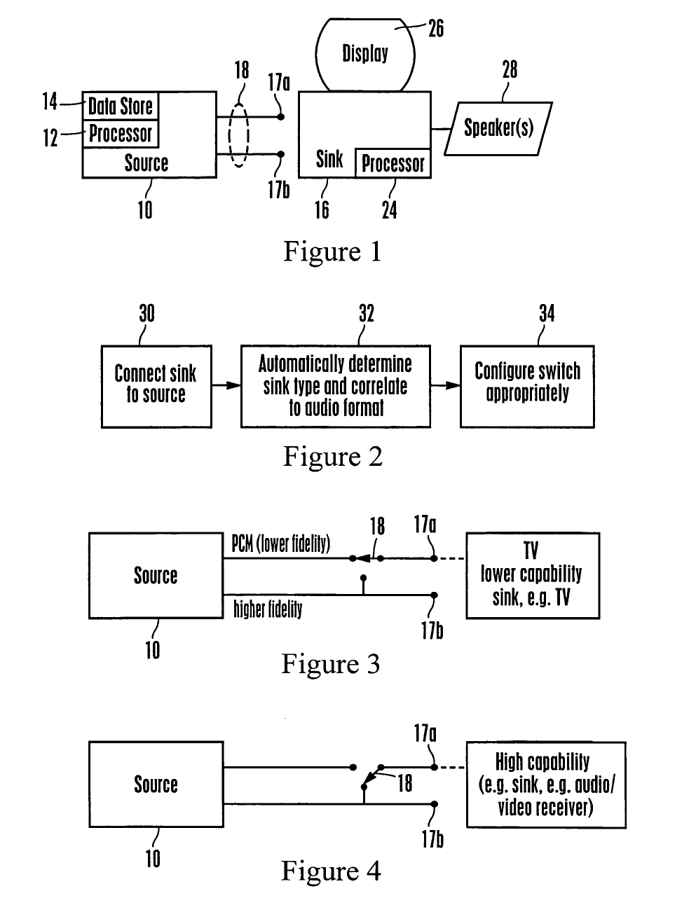

Referring initially to FIG. 1, the general non-liming embodiment for an audio/video delivery system is shown. As shown, a digital multimedia source device 10 includes a processor 12 and data storage 14 that be a disk or other storage that can hold multimedia streams. The source 10 can be any digital multimedia source device that outputs an audio/video format. For example, the source 10 may be a digital video disk (DVD) player that can output digital multimedia conforming to the High Definition Multimedia Interface (HDMI) standard or other standards, or the source 10 may be other sources of multimedia such as, e.g., set-top boxes, game consoles such as but not limited to Sony's Playstation 3, etc.

FIG. 1 shows that a sink device 16 is electronically connected to the source 10, and can be a television (TV) or home theater receiver or other appropriate player of multimedia streams. The source 10 can be electronically connected to the sink device 16 through one of two source ports 17a, 17b to which the sink 16 is connected. The format suited for the particular port is either a first audio format using at least two audio channels or a second audio format using at least one more audio channel than is used in the first format. For example, the first audio format that might be sent through the first port 17a can be a pulse code modulation (PCM) format such as stereo, while the second audio format that might be sent through the port 17b can be AC3, Super Audio compact disk-direct stream digital (CD-DSD), or surround sound format. Accordingly, in one non-limiting implementation the first port 17a can be a High Definition Multimedia Interface port while the second port 17b can be a Sony/Phillips Digital Interface Format (S/PDIF) port.

In accordance with the present invention, the source device 10 has at least one switch 18 that allows the appropriate format to be sent across the appropriate port or ports in accordance with disclosure below. In one non-limiting implementation the switch 18 may be a multiplexer, although other types of hardware or software switches may be used. Concluding the description of FIG. 1 the sink device 16 has a processor 24, a non-limiting video display 26, and plural speakers 28.

With the above structure in mind, operation of the system can now be understood in reference to FIG. 2, in which the logic used by the source device 10 to determine the appropriate audio format to be sent is shown. Beginning at block 30, a user must electronically connect the source device 10 to the sink device 16 through the specific port available, e.g., either an S/PDIF or HDMI port, on the sink device 16. At block 32, the source device determines the highest bit rate digital audio format supported by the sink device 16. To do this, the source 10 determines the type of sink device and then correlates the type to the appropriate audio format. One illustrative but non-limiting way to determine sink device type is to access sink device information on the bus (e.g., I2C bus) over which the multimedia streams are transmitted, it being understood that the sink device makes its type information available on the I2C bus. Concluding at block 34, the source device 10 configures the switch 18 to send the highest bit rate digital audio format supported by the sink device 16 across the appropriate port.

FIGS. 3 and 4 illustrate different results of block 34. In FIG. 3, a lower capability sink device such as a TV has been detected, so the switch 18 is configured to pass only lower bit rate (e.g., PCM) audio over the lower bit rate port 17a (typically, the only port to which the TV audio port can be connected) while higher bit rate audio is still available at the higher bit rate port 17b, so that a higher capability sink such as an A/V receiver can be engaged with the port 17b to receive higher bit rate audio. In contrast, in FIG. 4 the source 10 has detected that a full capability sink device such as an audio-video receiver in a home entertainment network has been connected to the source, so the switch 18 is configured to pass only high bit rate (e.g., AC3) audio to both ports 17a, 17b. In this way, only higher bit rate audio is received by the higher capability sink regardless of which port 17a, 17b into which it might happen to be plugged.

While the particular METHOD AND SYSTEM FOR AUTOMATICALLY SELECTING DIGITAL AUDIO FORMAT BASED ON SINK DEVICE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. Absent express definitions herein, claim terms are to be given all ordinary and accustomed meanings that are not irreconcilable with the present specification and file history.

What is claimed is:

1. A method for providing digital audio to a sink device, comprising:
establishing communication between a multimedia source device and the sink device;
at the source device, determining a type of sink device based on information from the sink device; and
at the source device, automatically selecting an audio format to provide to the sink device based at least in part on the type of sink device.

2. The method of claim 1, wherein a first audio format is provided in using at least two audio channels and a second audio format is provided using at least one more audio channel than is used in the first audio format.

3. The method of claim 2, wherein the first audio format is pulse code modulation (PCM) and the second audio format is AC3.

4. The method of claim 2, wherein the first audio format is pulse code modulation (PCM) and the second audio format is Super Audio compact disk-direct stream digital (CD-DSD).

5. The method of claim 2, wherein the first audio format is a stereo format and the second audio format is a surround sound format.

6. The method of claim 2, wherein the source device is a DVD player, the sink device is a TV, and the first audio format is provided to the TV.

7. The method of claim 2, wherein the source device is a DVD player, the sink device is a home theater receiver, and the second audio format is provided to the receiver.

8. The method of claim 1, wherein the multimedia is provided using High Definition Multimedia Interface (HDMI).

9. A digital multimedia source device, comprising:
at least one processor;
at least one data store storing at least one multimedia stream including at least first and second audio formats, the first format having a relatively lower bit rate than the second format;
at least one switch, wherein
the processor automatically controls the switch to select at least one of the formats for output to a sink device, based on a type of sink device.

10. The source device of claim 9, wherein the processor moves the switch to a first configuration in which the second format is provided on first and second source ports based on the processor determining a sink type of relatively high audio capability.

11. The source device of claim 9, wherein the processor moves the switch to a second configuration in which the first format is provided on a first source port and the second format is provided on a second source port based on the processor determining a sink type of relatively low audio capability.

12. The source device of claim 10, wherein the processor moves the switch to a second configuration in which the first format is provided on the first source port and the second format is provided on the second source port based on the processor determining a sink type of relatively low audio capability.

13. The source device of claim 9, wherein the first audio format is pulse code modulation (PCM) and the second audio format is at least one of AC3 or Super Audio compact disk-direct stream digital (CD-DSD).

14. The source device of claim 9, wherein the source device is a DVD player, the sink device is a TV, and the first audio format is provided to the TV.

15. The source device of claim 9, wherein the source device is a DVD player, the sink device is a home theater receiver, and the second audio format is provided to the receiver.

16. The source device of claim 9, wherein the multimedia is provided using High Definition Multimedia Interface (HDMI).

17. The source device of claim 9, comprising first and second source device ports, the first port being a HDMI port and the second port being a Digital Interface Format port.

18. A processor comprising:
means for determining a multimedia sink device type; and
means, responsive to the means for determining, for automatically configuring a multimedia source device to output at least one audio format.

19. The processor of claim 18, wherein the processor is in the source device.

20. The processor of claim 18, comprising at least one switch, wherein
the processor moves the switch to a first configuration in which the second format is provided on first and second source ports based on the processor determining a sink type of relatively high audio capability, the processor moving the switch to a second configuration in which the first format is provided on the first source port and the second format is provided on the second source port based on the processor determining a sink type of relatively low audio capability.
